(19) United States
(12) Patent Application Publication
(10) Pub. No.: US 2026/0188752 A1
(43) Pub. Date: Jul. 2, 2026

(54) METHOD OF MANUFACTURING ALL-SOLID-STATE BATTERY

(71) Applicant: HONDA MOTOR CO., LTD., Tokyo (JP)

(72) Inventors: Yayoi MATSUSHITA, Saitama (JP); Satoshi AOKI, Saitama (JP); Hirotaka SANO, Saitama (JP); Tsugio MASUDA, Saitama (JP)

(73) Assignee: HONDA MOTOR CO., LTD., Tokyo (JP)

(21) Appl. No.: 19/414,275

(22) Filed: Dec. 10, 2025

(30) Foreign Application Priority Data
Dec. 26, 2024 (JP) 2024-229768

(51) Int. Cl. H01M 10/058; H01M 4/04

(52) U.S. Cl. CPC H01M 10/058; H01M 4/0435

(57) ABSTRACT

In a method of manufacturing an all-solid-state battery, a solid electrolyte layer is pressed onto a positive electrode sheet member. The method includes a step of transferring the solid electrolyte layer to the positive electrode sheet member, and a step of refining the solid electrolyte layer transferred in the transferring and the positive electrode sheet member on the same line.

### CROSS-REFERENCE TO RELATED APPLICATIONS

This application is based on and claims priority under 35 USC 119 from Japanese Patent Application No. 2024-229768 filed on December 26, 2024, the entire content of which is incorporated herein by reference.

### TECHNICAL FIELD

The present disclosure relates to a method of manufacturing an all-solid-state battery.

### BACKGROUND ART

In recent years, researches and developments have been conducted on a secondary battery which contributes to improvement in energy efficiency in order to allow more people to have access to affordable, reliable, sustainable and advanced energy.

In the related art, as a method of manufacturing an all-solid-state battery, there is known a manufacturing method of pressing a positive electrode layer, a solid electrolyte layer, and a negative electrode layer with a roll (for example, JP2020-161471A).

In the method of manufacturing a solid-state battery described in JP2020-161471A, a sheet on which the solid electrolyte layer is provided is pressed onto the positive electrode layer to transfer the solid electrolyte layer to the positive electrode layer, but accuracy of the transfer of the solid electrolyte layer may decrease.

### SUMMARY OF INVENTION

The present disclosure provides a method of manufacturing an all-solid-state battery, which enables to accurately transfer a solid electrolyte layer to a positive electrode layer. This further contributes to improvement in energy efficiency.

An aspect of the present disclosure is to a method of manufacturing an all-solid-state battery, in which a solid electrolyte layer is pressed onto a positive electrode sheet member, the method including:

transferring the solid electrolyte layer to the positive electrode sheet member; and

refining the solid electrolyte layer transferred in the transferring and the positive electrode sheet member on a same line.

According to the aspect of the present disclosure, it is possible to accurately transfer the solid electrolyte layer to the positive electrode layer. This further contributes to improvement in energy efficiency.

### BRIEF DESCRIPTION OF DRAWINGS

Exemplary embodiment(s) of the present invention will be described in detail based on the following figures, wherein:

FIG. 1 is a cross-sectional view illustrating an example of an all-solid-state battery 1;

FIG. 2 is a diagram illustrating an example of a press device 100 for manufacturing the all-solid-state battery 1 according to an embodiment;

FIG. 3 is a diagram illustrating a part of the press device 100, and is particularly a diagram illustrating an example of transfer of a first solid electrolyte layer SE1;

FIG. 4 is a schematic diagram illustrating an example of an expander roll 110;

FIG. 5 is a diagram illustrating a part of the press device 100, and is particularly a diagram illustrating an example of transfer by an intermediate layer transfer roller 150 and a negative electrode transfer roller 160; and

FIG. 6 is a flowchart showing an example of a method for manufacturing the all-solid-state battery 1.

### DESCRIPTION OF EMBODIMENTS

Hereinafter, an embodiment will be described with reference to the accompanying drawings. First, before describing a method of manufacturing an all-solid-state battery 1, a configuration of the all-solid-state battery 1 and a configuration of a press device 100 used in manufacturing the all-solid-state battery 1 will be described.

### <All-Solid-State Battery>

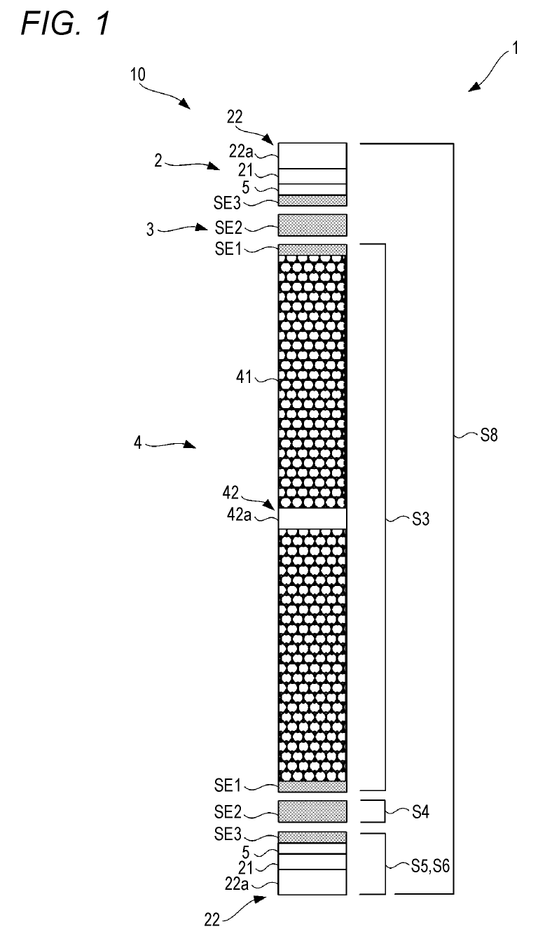

FIG. 1 is a schematic diagram illustrating an example of the all-solid-state battery 1. The all-solid-state battery 1 includes an electrode 10 in which a negative electrode layer 2, a solid electrolyte layer 3, and a positive electrode layer 4 are laminated. In the embodiment, as illustrated in FIG. 1, a structure in which the negative electrode layer 2, the solid electrolyte layer 3, the positive electrode layer 4, the solid electrolyte layer 3, and the negative electrode layer 2 are laminated in this order will be described as a lamination structure of the all-solid-state battery 1. Note that the structure of the all-solid-state battery 1 is not limited to the above. The all-solid-state battery 1 may have, for example, a configuration that can be used for a solid-state battery such as an exterior body in addition to the electrode 10 illustrated in FIG. 1.

The solid electrolyte layer 3 in the all-solid-state battery 1 has at least a first solid electrolyte layer SE1 disposed on a side of the positive electrode layer 4 and a negative electrode side solid electrolyte layer SE3 disposed on a side of the negative electrode layer 2. The solid electrolyte layer 3 may have a second solid electrolyte layer SE2 disposed adjacent to the first solid electrolyte layer SE1. In the embodiment, the solid electrolyte layer 3 will be described as being constituted by the above three layers. An intermediate layer 5 may be optionally disposed between the negative electrode layer 2 and the solid electrolyte layer 3.

The all-solid-state battery 1 is not particularly limited, and may be a lithium ion solid-state secondary battery or a lithium metal secondary battery.

### (Negative Electrode Layer)

The negative electrode layer 2 has a negative electrode active material layer 21 and a negative electrode current collector layer 22. The negative electrode active material layer 21 is not particularly limited, and can be made of a material that can be used as a negative electrode active material for the all-solid-state battery 1. Examples of the negative electrode active material constituting the negative electrode active material layer 21 include lithium metal, lithium alloys, silicon-based active materials such as Si and Si alloys, lithium transition metal oxides such as lithium titanate (Li₄Ti₅O₁₂), transition metal oxides such as TiO₂, Nb₂O₃ and WO₃, metal sulfides, metal nitrides, carbon materials such as graphite, soft carbon and hard carbon, and metallic indium.

The negative electrode active material layer 21 may contain materials that can be contained in the negative electrode active material layer 21 of the all-solid-state battery 1 in addition to the above. Examples of the materials include a solid electrolyte, a conductive assistance, and a binder. Examples of the solid electrolyte are the same as the solid electrolyte contained in the solid electrolyte layer 3 described below. Examples of the conductive assistance include carbon black, natural graphite, carbon fiber, and carbon nanotubes. Examples of the binder include nitrile polymers, polyester polymers, acrylic acid polymers, cellulose polymers, styrene polymers, styrene butadiene polymers, vinyl acetate polymers, urethane polymers, and fluoroethylene polymers.

The negative electrode current collector layer 22 is not particularly limited and may be made of copper, nickel, stainless steel, or the like. Examples of a shape of the negative electrode current collector layer 22 include a foil shape, a plate shape, a mesh shape, a nonwoven fabric shape, and a foam shape. In the embodiment, the negative electrode current collector layer 22 is made of a negative electrode current collecting foil 22a.

### (Solid Electrolyte Layer)

The solid electrolyte layer 3 is formed between the negative electrode layer 2 and the positive electrode layer 4. In the embodiment, the solid electrolyte layer 3 has a structure in which the first solid electrolyte layer SE1 disposed in contact with the positive electrode layer, the second solid electrolyte layer SE2, and the negative electrode side solid electrolyte layer SE3 disposed on the side of the negative electrode layer 2 are laminated in this order.

The first solid electrolyte layer SE1 is disposed in contact with a positive electrode active material layer 41 in the positive electrode layer 4. A solid electrolyte constituting the first solid electrolyte layer SE1 is not particularly limited and may be a material that can be used as an electrolyte for a solid-state battery. Examples thereof include inorganic solid electrolytes such as sulfide solid electrolytes, oxide solid electrolytes, halide solid electrolytes, and lithium-containing salts, and polymer-based solid electrolytes such as polyethylene oxide. The above-described solid electrolytes may be used alone or two or more thereof may be used in combination.

The first solid electrolyte layer SE1 contains a binder in addition to the solid electrolyte material. As the binder, the same material as the binder that can be contained in the negative electrode active material layer 21 can be used. A content of the binder in the first solid electrolyte layer SE1 with respect to a mass of the entire first solid electrolyte layer SE1 is equal to or greater than a content of the binder in the second solid electrolyte layer SE2 with respect to a mass of the entire second solid electrolyte layer SE2. An upper limit of the content of the binder in the first solid electrolyte layer SE1 is, for example, 25 mass%. The content of the binder in the first solid electrolyte layer SE1 is preferably 10 mass% to 30 mass%. Accordingly, it becomes easy for the first solid electrolyte layer SE1 to elongate following the positive electrode layer 4 when the positive electrode layer 4 is pressed (stamped).

Note that in addition to the solid electrolyte material and the binder, the first solid electrolyte layer SE1 may contain a material that can be used for a solid electrolyte layer of a solid-state battery.

A thickness of the first solid electrolyte layer SE1 (a length in a lamination direction of each layer) is preferably smaller than a thickness of the second solid electrolyte layer SE2. The thickness of the first solid electrolyte layer SE1 is preferably, for example, 3 μm to 15 μm.

The second solid electrolyte layer SE2 is a layer disposed freely and is disposed adjacent to the first solid electrolyte layer SE1. A solid electrolyte material constituting the second solid electrolyte layer SE2 is not particularly limited and may be the same material as the solid electrolyte material constituting the first solid electrolyte layer SE1. Similarly to the first solid electrolyte layer SE1, the second solid electrolyte layer SE2 may contain a binder or the like in addition to the solid electrolyte material. A content of the binder in the second solid electrolyte layer SE2 is equal to or less than the content of the binder in the first solid electrolyte layer SE1. The content of the binder in the second solid electrolyte layer SE2 is preferably, for example, 10 mass% to 30 mass%. Accordingly, energy density of the all-solid-state battery 1 can be improved. The second solid electrolyte layer SE2 may include a support. The support may be a three-dimensional structure such as a mesh, a woven fabric, a nonwoven fabric, an embossed body, a punched body, an expanded body, or foam. The second solid electrolyte layer SE2 may not contain the support.

The thickness of the second solid electrolyte layer SE2 (a length in the lamination direction of each layer) is preferably greater than the thickness of the first solid electrolyte layer SE1. The thickness of the second solid electrolyte layer SE2 is preferably greater than a thickness of the negative electrode side solid electrolyte layer SE3 described below. The thickness of the second solid electrolyte layer SE2 is preferably, for example, 10 μm to 50 μm.

The negative electrode side solid electrolyte layer SE3 is disposed on the side of the negative electrode layer 2. The negative electrode side solid electrolyte layer SE3 is disposed adjacent to the negative electrode layer 2. When the all-solid-state battery 1 includes the intermediate layer 5 as illustrated in FIG. 1, the negative electrode side solid electrolyte layer SE3 may be disposed adjacent to the intermediate layer 5.

A solid electrolyte material constituting the negative electrode side solid electrolyte layer SE3 is not particularly limited and may be the same material as the solid electrolyte material constituting the first solid electrolyte layer SE1. A content of the binder in the negative electrode side solid electrolyte layer SE3 is preferably, for example, 1.3 mass% to 8.7 mass%. In terms of vol%, the content of the binder in the negative electrode side solid electrolyte layer SE3 is preferably, for example, 2.7 vol% to 10 vol%. The content of the binder in the negative electrode side solid electrolyte layer SE3 is less than the content of the binder in the first solid electrolyte layer SE1.

The thickness of the negative electrode side solid electrolyte layer SE3 (a length in the lamination direction of each layer) is preferably smaller than the thickness of the second solid electrolyte layer SE2. The thickness of the negative electrode side solid electrolyte layer SE3 is preferably, for example, 3 μm to 8.5 μm.

### (Positive Electrode Layer)

The positive electrode layer 4 includes the positive electrode active material layer 41 and a positive electrode current collector layer 42. In the embodiment, the positive electrode layer 4 has a configuration in which two positive electrode active material layers 41 are laminated on both surfaces of one positive electrode current collector layer 42. Note that the configuration of the positive electrode layer 4 is not limited to the above, and a configuration may be adopted in which one positive electrode active material layer 41 is laminated on a single surface of one positive electrode current collector layer 42.

The positive electrode active material layer 41 is not particularly limited and may be made of a material that can be used as a positive electrode active material of a solid-state battery. Examples of the positive electrode active material constituting the positive electrode active material layer 41 include layered positive electrode active material particles such as LiCoO₂, LiNiO₂, LiCoₓNi_{y}Mn_{z}O₂ (x + y + z = 1), LiVO₂, and LiCrO₂, spinel-type positive electrode active materials such as LiMn₂O₄, Li(Ni_{0.25}Mn_{0.75})₂O₄, LiCoMnO₄, and Li₂NiMn₃O₈, olivine-type positive electrode active materials such as LiCoPO₄, LiMnPO₄, and LiFePO₄, solid solution oxides (Li₂MnO₃-LiMO₂ (M = Co, Ni, or the like), conductive polymers such as polyaniline and polypyrrole, sulfides such as Li₂S, CuS, Li-Cu-S compounds, TiS₂, FeS, MoS₂, and Li-Mo-S compounds, and mixtures of sulfur and carbon. The positive electrode active material may contain one of the above materials or may contain two or more of the above materials.

The positive electrode active material layer 41 may contain a binder, a conductive assistance, and the like. For example, a content of the binder in the positive electrode active material layer 41 is preferably 0.5 mass% to 5 mass%. Preferably, the content may be 2.56 mass%. A thickness of the positive electrode active material layer 41 (a length in the lamination direction of each layer) is preferably, for example, 80 μm to 100 μm. Accordingly, a battery capacity of the all-solid-state battery 1 can be improved.

The positive electrode current collector layer 42 is not particularly limited and may be made of, for example, aluminum, stainless steel, or conductive carbon (for example, graphite or carbon nanotube). Examples of a shape of the positive electrode current collector layer 42 include a foil shape, a plate shape, a mesh shape, a nonwoven fabric shape, and a foam shape. In the embodiment, the positive electrode current collector layer 42 is made of a positive electrode current collecting foil 42a.

### (Intermediate Layer)

The intermediate layer 5 is disposed between the negative electrode layer 2 and the solid electrolyte layer 3. For example, when the all-solid-state battery 1 is a lithium metal battery, the intermediate layer 5 has a function of uniformly depositing lithium metal. Therefore, an interface between the intermediate layer 5 and the solid electrolyte layer 3 is stabilized. When the all-solid-state battery 1 is a lithium metal secondary battery including the intermediate layer 5, the all-solid-state battery 1 may be an anode-free battery in which the negative electrode active material layer 21 does not exists during an initial charge. In this case, a lithium metal layer as the negative electrode active material layer 21 is formed after initial charge and discharge.

A material constituting the intermediate layer 5 is not particularly limited, and examples thereof include a metal that can alloy with lithium and amorphous carbon. Examples of the metal that can alloy with lithium include tin (Sn), silicon (Si), zinc (Zn), magnesium (Mg), gold (Au), platinum (Pt), palladium (Pd), silver (Ag), aluminum (Al), bismuth (Bi), and antimony (Sb). The metal that can alloy with lithium may be nanoparticles. Examples of the amorphous carbon include carbon black such as acetylene black, furnace black, and Ketjen black, coke, and activated carbon. The amorphous carbon may be easily graphitizable carbon (soft carbon), hardly graphitizable carbon (hard carbon), carbon nanotube (CNT), fullerene, or graphene. The intermediate layer may contain a binder in addition to the above materials.

### <Press Device>

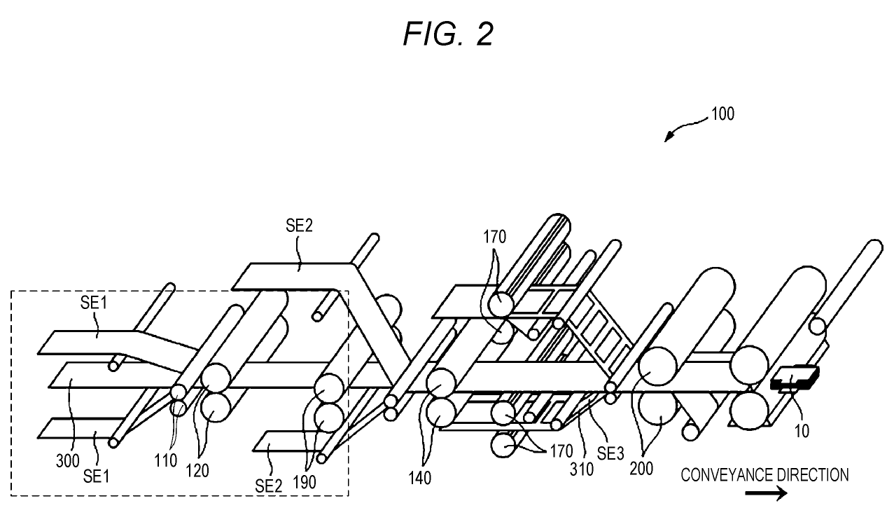

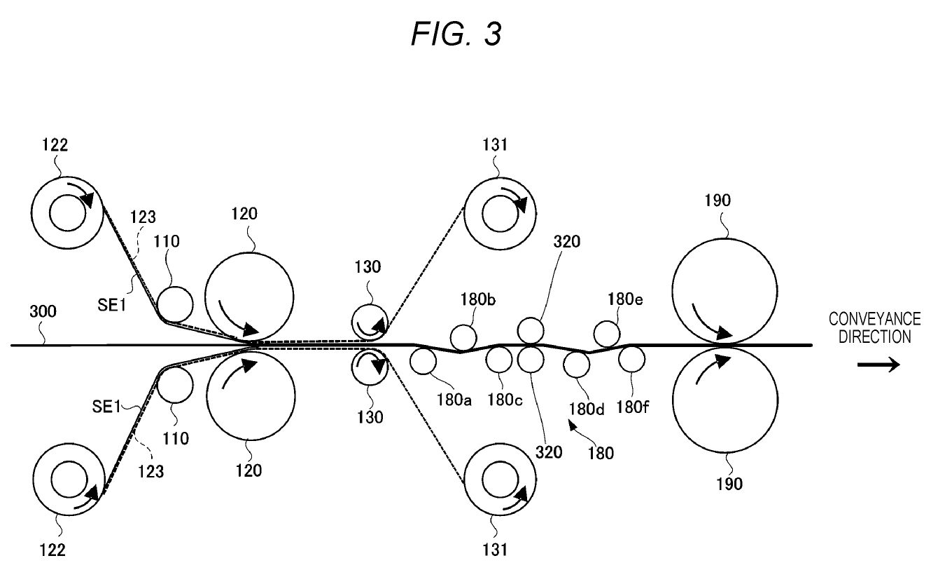

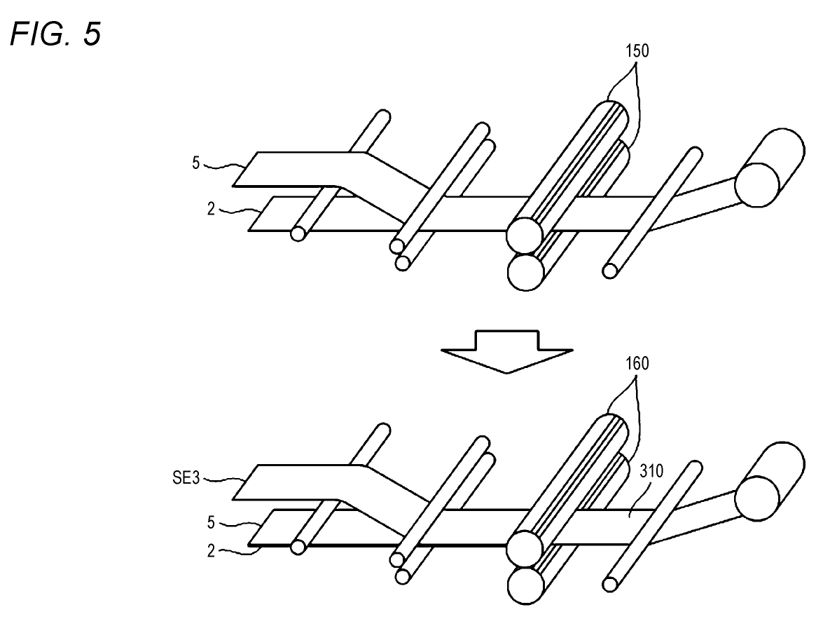

Next, a configuration of the press device 100 for manufacturing the all-solid-state battery 1 configured as described above will be described. FIG. 2 illustrates an example of the press device 100 in the embodiment. The press device 100 includes, as main components, an expander roll 110, a first positive electrode transfer roller 120, a peeling roller 130 (see FIG. 3), a second positive electrode transfer roller 140, an intermediate layer transfer roller 150 (see FIG. 5), a negative electrode transfer roller 160 (see FIG. 5), a negative electrode sheet member lamination roller 170, a vertically movable guide roll 180 (see FIG. 3), a positive electrode press roll 190, and an integration press roll 200. The press device 100 continuously manufactures the all-solid-state battery 1 while feeding out the positive electrode sheet member 300 in one direction using each of these rollers and rolls. Note that FIG. 1 illustrates a range to be stamped or pressed to transfer in a positive electrode press step S5, a second solid electrolyte layer transfer step S6, an intermediate layer transfer step S7, a negative electrode side solid electrolyte layer transfer step S8, and an integration press step S10, which will be described below.

The positive electrode sheet member 300 is a sheet-like member obtained by laminating the positive electrode active material layer 41 on the positive electrode current collecting foil 42a constituting the positive electrode current collector layer 42. The positive electrode sheet member 300 is fed out by a roller (not illustrated) and conveyed to continuously extend from a base end side to a terminal end in a manufacturing line of the all-solid-state battery 1.

The expander roll 110, the first positive electrode transfer roller 120, the peeling roller 130, the second positive electrode transfer roller 140, the intermediate layer transfer roller 150, the negative electrode transfer roller 160, and the negative electrode sheet member lamination roller 170 are each constituted by a pair of rotating bodies.

These rotating bodies are arranged along a conveyance direction, which is a direction in which the positive electrode sheet member 300 is conveyed (hereinafter simply referred to as a "conveyance direction"), in an order from an upstream side of the expander roll 110, the first positive electrode transfer roller 120, the peeling roller 130, the vertically movable guide roll 180, the positive electrode press roll 190, the second positive electrode transfer roller 140, the negative electrode sheet member lamination roller 170, and the integration press roll 200. Therefore, processing such as pressing (stamping) by these rotating bodies are performed on the same conveyance line, which is the conveyance direction of the positive electrode sheet member 300 (hereinafter referred to as a "conveyance line").

The intermediate layer transfer roller 150 and the negative electrode transfer roller 160 are arranged such that the positive electrode sheet member 300 is away from the conveyance line, and perform transfer pressing on the intermediate layer 5 or the negative electrode side solid electrolyte layer SE3. Thereafter, as will be described below, the intermediate layer 5 and the negative electrode layer 2 to which the negative electrode side solid electrolyte layer SE3 is transferred are conveyed to an upper surface side or a lower surface side of the positive electrode sheet member 300, join the conveyance line of the positive electrode sheet member 300, and are laminated by the negative electrode sheet member lamination roller 170.

The first positive electrode transfer roller 120, the second positive electrode transfer roller 140, the intermediate layer transfer roller 150, and the negative electrode transfer roller 160 perform the transfer pressing by sandwiching a sheet such as a base material subjected to the transferring and a sheet provided with a solid electrolyte layer to be transferred between a pair of rollers and passing the sheets through the pair of rollers while applying a pressure thereto.

Specifically, the first positive electrode transfer roller 120 transfers the first solid electrolyte layer SE1 to the positive electrode sheet member 300 by sandwiching a transfer sheet 121, which is a sheet on which the first solid electrolyte layer SE1 or the like is provided, between a pair of rollers while applying a pressure thereto.

In the embodiment, as described above, the expander roll 110 is disposed upstream of the first positive electrode transfer roller 120. The expander roll 110 is configured to, before the first positive electrode transfer roller 120 transfers the first solid electrolyte layer SE1 to the positive electrode sheet member 300, apply a tension to the transfer sheet 121 in a width direction perpendicular to the conveyance direction of the positive electrode sheet member 300 (hereinafter simply referred to as a "width direction"), and adjust a penetration angle of the transfer sheet 121 with respect to the positive electrode sheet member 300 by making the transfer sheet 121 parallel to the positive electrode sheet member 300.

Here, a reason why the expander roll 110 is provided in the embodiment will be described. For example, as known in the related art, when the first solid electrolyte layer SE1 is transferred to the positive electrode sheet member 300 by the first positive electrode transfer roller 120 in a state where the expander roll 110 is not provided, the transferring may not be performed properly. Especially, since no tension is applied in the width direction, accuracy of the transferring of the first solid electrolyte layer SE1 may decrease. If the accuracy of transferring decreases in this way, accuracy of bonding between the first solid electrolyte layer SE1 and the positive electrode layer 4 (positive electrode active material layer 41) may also decrease. Therefore, in the embodiment, the expander roll 110 is provided to improve the accuracy of the transferring of the first solid electrolyte layer SE1.

FIG. 3 is an enlarged view illustrating a portion surrounded by a broken line in FIG. 2 in more detail. The expander roll 110 applies the tension in the width direction as well as the conveyance direction to the transfer sheet 121 unwound from a transfer sheet roll body 122 around which the transfer sheet 121 is wound. Note that arrows illustrated in rollers and roll bodies in FIG. 3 indicate rotation directions of the rollers and the roll bodies.

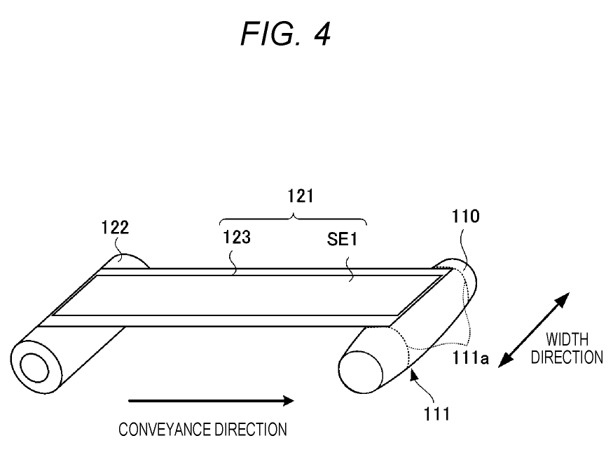

Specifically, as illustrated in FIG. 4, the expander roll 110 is a roll body that extends in the width direction, and a diameter of a central portion thereof is larger than diameters of both ends. In other words, the expander roll 110 has a so-called crown shape in which an outer diameter gradually decreases from the central portion side toward the end sides. A cross section of the crown shape may be a tapered shape that is linear from the central portion side toward the end sides, or may be a curved shape that is curved from the central portion side toward the end sides. Although not illustrated, the expander roll 110 may be configured such that a straight roll is bent so as to be convex at the central portion side toward the transfer sheet 121, or may be configured such that the outer diameter thereof gradually decreases from the end sides toward the central portion side.

With this shape, the transfer sheet 121 is pulled toward both ends, that is, the tension is applied thereto in the width direction. Note that regarding a tension in the conveyance direction, it can be assumed that a certain degree of tension is applied even when the expander roll 110 is not provided, but it is assumed that the tension in the conveyance direction is greater when the expander roll 110 is provided.

Note that as illustrated in FIGS. 3 and 4, the transfer sheet 121 includes the first solid electrolyte layer SE1 and a base material sheet 123 provided with the first solid electrolyte layer SE1. The base material sheet 123 is peeled off from the transferred first solid electrolyte layer SE1 by the peeling roller 130 described below, and is made of, for example, PET (polyethylene terephthalate), stainless steel, aluminum, or the like. In FIG. 3, in the transfer sheet 121 unwound from the transfer sheet roll body 122, the first solid electrolyte layer SE1 is indicated by a solid line, and the peeled base material sheet 123 is indicated by a broken line.

The expander roll 110 in the embodiment is formed with a positioning portion 111 for positioning the transfer sheet 121. In the example illustrated in FIG. 4, as an example of the positioning portion 111, a guide groove 111a for guiding the transfer sheet 121 is formed. The transfer sheet 121 is guided by the guide groove 111a, so that movement of the transfer sheet 121 in the width direction can be restricted. Note that the positioning portion 111 may have any other configuration as long as the positioning portion 111 can position the transfer sheet 121 in the width direction. For example, instead of the guide groove 111a, a pair of barrier portions may be formed in the width direction.

The transfer sheet 121 conveyed via the expander roll 110 is then transferred to the positive electrode sheet member 300 by the first positive electrode transfer roller 120. In order to accurately perform this transferring, it is preferable that the transfer sheet 121 and the positive electrode sheet member 300 are parallel to each other during the transfer pressing by the first positive electrode transfer roller 120. In the embodiment, as described above, the expander roll 110 is formed with the positioning portion 111 for positioning the transfer sheet 121, so that the tension in the width direction (as well as the conveyance direction) is applied to the transfer sheet 121, and the transfer sheet 121 and the positive electrode sheet member 300 can be brought into the desired parallel state.

In this way, the expander roll 110 not only has a function of applying the tension to the transfer sheet 121 in the width direction, but also has a function of making the transfer sheet 121 parallel to the positive electrode sheet member 300. In other words, the expander roll 110 also has a function of adjusting a penetration angle of the transfer sheet 121 to the positive electrode sheet member 300 to achieve the parallel state.

The peeling roller 130 is disposed downstream of the first positive electrode transfer roller 120. The peeling roller 130 peels the base material sheet 123 from the transfer sheet 121 on which the first solid electrolyte layer SE1 is provided. Specifically, as illustrated in FIG. 3, the base material sheet 123 is peeled off from the first solid electrolyte layer SE1 subjected to the transfer pressing. In this case, the peeling roller 130 also functions as a pressure when peeling the base material sheet 123 from the first solid electrolyte layer SE1. The peeled base material sheet 123 is then wound up by a base material roll body 131 that winds up the base material sheet 123.

In this way, the tension is applied to the transfer sheet 121 unwound from the transfer sheet roll body 122 mainly in the width direction by the expander roll 110, and under this state, the first solid electrolyte layer SE1 is transferred to the positive electrode sheet member 300 by the first positive electrode transfer roller 120. Then, the base material sheet 123 is wound and taken up from the transferred first solid electrolyte layer SE1 to the base material roll body 131 via the peeling roller 130.

Note that as illustrated in FIG. 3, the transfer sheet 121 is provided on both surfaces of the positive electrode sheet member 300 with the positive electrode sheet member 300 interposed therebetween in a vertically symmetric manner, and the first solid electrolyte layer SE1 is configured to be transferred to both surfaces of the positive electrode sheet member 300. Accordingly, the first solid electrolyte layer SE1 can be simultaneously transferred to both surfaces of the positive electrode sheet member 300.

On the other hand, when the first solid electrolyte layer SE1 is transferred to the positive electrode sheet member 300 by the first positive electrode transfer roller 120 and the base material sheet 123 is wound and taken up from the transferred first solid electrolyte layer SE1 by the peeling roller 130, distortion may occur in the positive electrode sheet member 300 due to a relation between a pressure generated when transferring the first solid electrolyte layer SE1 and a shear force generated when peeling the base material sheet 123 from the first solid electrolyte layer SE1. When such distortion occurs, if an attempt is made to refine and densify the first solid electrolyte layer SE1 and the positive electrode sheet member 300 using the positive electrode press roll 190 described below, accuracy of transferring between the positive electrode sheet member 300 and the first solid electrolyte layer SE1 may decrease. Therefore, in the embodiment, the vertically movable guide roll 180 is provided to prevent distortion of the positive electrode sheet member 300 after the transferring by the first positive electrode transfer roller 120 and the peeling by the peeling roller 130.

The vertically movable guide roll 180 corrects the distortion that occurs in the positive electrode sheet member 300 to which the first solid electrolyte layer SE1 is transferred. That is, the pressure applied by the transferring by the first positive electrode transfer roller 120 is temporarily released or reduced, thereby making the tension applied to the positive electrode sheet member 300 uniform. That is, the vertically movable guide roll 180 controls the tension applied by the transferring by the first positive electrode transfer roller 120 and the peeling by the peeling roller 130.

In the embodiment, a plurality of the vertically movable guide rolls 180 are provided. In the example illustrated in FIG. 3, six vertically movable guide rolls 180 are provided on both surface sides of the positive electrode sheet member 300, with the positive electrode sheet member 300 interposed therebetween. These vertically movable guide rolls 180 are defined here as, from the upstream side, a first vertically movable guide roll 180a, a second vertically movable guide roll 180b, a third vertically movable guide roll 180c, a fourth vertically movable guide roll 180d, a fifth vertically movable guide roll 180e, and a sixth vertically movable guide roll 180f. In the example of FIG. 3, as an example, the first vertically movable guide roll 180a, the third vertically movable guide roll 180c, the fourth vertically movable guide roll 180d, and the sixth vertically movable guide roll 180f are arranged on a lower surface side of the positive electrode sheet member 300, and the second vertically movable guide roll 180b and the fourth vertically movable guide roll 180d are arranged on an upper surface side of the positive electrode sheet member 300. Such an arrangement may be changed as appropriate depending on the distortion of the positive electrode sheet member 300. For example, the same number of vertically movable guide rolls 180 may be arranged on the upper surface side and the lower surface side of the positive electrode sheet member 300. For example, similar to the configuration of the first positive electrode transfer roller 120 and the like, the vertically movable guide rolls 180 may be provided so as to face each other with the positive electrode sheet member 300 interposed therebetween.

Note that on the conveyance line, similar to the vertically movable guide rolls 180, a pair of rolls arranged between the third vertically movable guide roll 180c and the fourth vertically movable guide roll 180d are adjustment rolls 320 for adjusting distortion of the positive electrode sheet member 300 to which the first solid electrolyte layer SE1 is transferred.

In this way, in the embodiment, the tension of the distorted positive electrode sheet member 300 is controlled and adjusted by the vertically movable guide rolls 180, thereby correcting the distortion of the positive electrode sheet member 300, improving accuracy of the subsequent pressing by the positive electrode press roll 190, and also improving accuracy of the transferring between the first solid electrolyte layer SE1 and the positive electrode sheet member 300.

As illustrated in FIG. 2, the second positive electrode transfer roller 140 transfers the second solid electrolyte layer SE2 to the positive electrode sheet member 300, to which the first solid electrolyte layer SE1 has been transferred and pressed (stamped).

As illustrated in FIG. 5, the intermediate layer transfer roller 150 transfers the intermediate layer 5 to the negative electrode active material layer 21 laminated on the negative electrode current collecting foil 22a. Accordingly, the intermediate layer 5 is disposed between the negative electrode active material layer 21 and the negative electrode side solid electrolyte layer SE3.

As illustrated in FIG. 5, the negative electrode transfer roller 160 forms a negative electrode sheet member 310 by transferring the negative electrode side solid electrolyte layer SE3 to the intermediate layer 5.

As illustrated in FIG. 2, the negative electrode sheet member lamination roller 170 conveys and laminates the negative electrode sheet member 310, to which the negative electrode side solid electrolyte layer SE3 is transferred, onto the positive electrode sheet member 300, to which the first solid electrolyte layer SE1 and the second solid electrolyte layer SE2 have been transferred.

Each of the positive electrode press roll 190 and the integration press roll 200 is constituted by a pair of rotating rollers similarly to each transfer roller, and the positive electrode sheet member 300 on which the solid electrolyte layers and the like are laminated by each processing is sandwiched between the pairs of rollers, passed through while being pressed by the pairs of rollers, and thus refined and densified. As illustrated in FIG. 3, the positive electrode press roll 190 has a larger outer diameter than the first positive electrode transfer roller 120 and applies a larger pressure when pressing (stamping). In the embodiment, the positive electrode press roll 190 presses (stamps) the positive electrode sheet member 300 to which the first solid electrolyte layer SE1 has been transferred. Note that a surface of the positive electrode press roll 190 is plated with, for example, hard chromium.

The integration press roll 200 presses (stamps) the positive electrode sheet member 300 and the negative electrode sheet member 310 in a laminated state to integrate the electrode 10. Accordingly, the positive electrode sheet member 300 and the negative electrode sheet member 310 are integrated, and at the same time, the first solid electrolyte layer SE1, the second solid electrolyte layer SE2, and the negative electrode side solid electrolyte layer SE3 achieve high densities.

### <Method of Manufacturing All-Solid-State Battery>

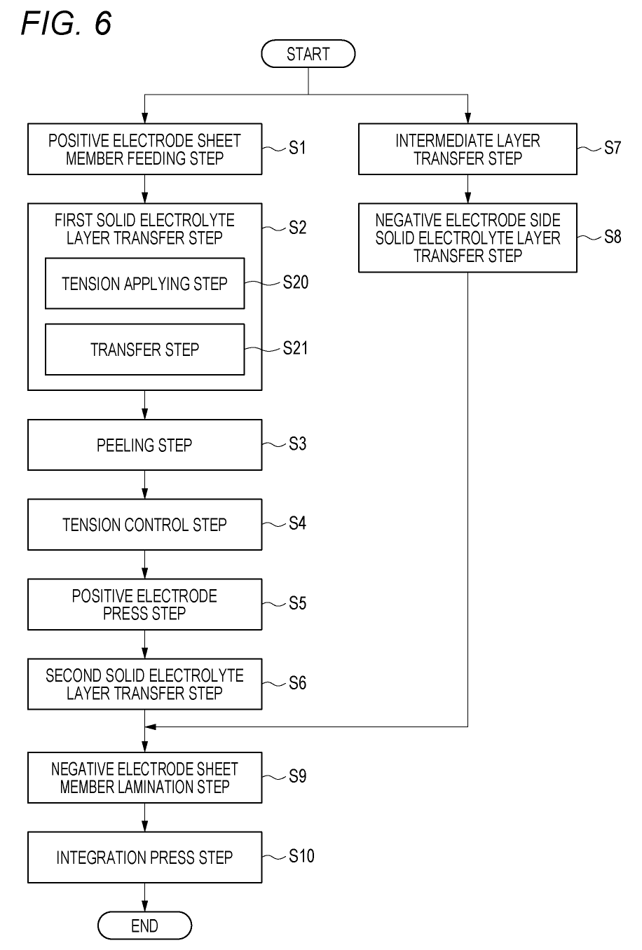

Next, a method of manufacturing an all-solid-state battery using the press device 100 for the all-solid-state battery 1 configured as described above will be described. FIG. 6 is a flowchart showing an example of the method for manufacturing the all-solid-state battery. The method of manufacturing the all-solid-state battery includes, as processing, a positive electrode sheet member feeding step S1, a first solid electrolyte layer transfer step S2, a peeling step S3, a tension control step S4, the positive electrode press step S5, the second solid electrolyte layer transfer step S6, the intermediate layer transfer step S7, the negative electrode side solid electrolyte layer transfer step S8, a negative electrode sheet member lamination step S9, and the integration press step S10. Note that the first solid electrolyte layer transfer step S2 includes a tension applying step S20 and a transfer step S21.

The positive electrode sheet member feeding step S1 is a step of conveying and feeding the positive electrode sheet member 300 by a conveying roller (not illustrated). That is, the positive electrode sheet member 300 on which the positive electrode active material is coated and laminated on the positive electrode current collecting foil 42a constituting the positive electrode current collector layer 42 is fed.

The first solid electrolyte layer transfer step S2 is a step of transferring the first solid electrolyte layer SE1 to the positive electrode sheet member 300 by the first positive electrode transfer roller 120. Specifically, the first solid electrolyte layer transfer step S2 includes the tension applying step S20 and the transfer step S21.

The tension applying step S20 is a step of applying the tension in the width direction to the transfer sheet 121 unwound from the transfer sheet roll body 122 by the expander roll 110 described above. That is, since the diameter on the central portion side of the expander roll 110 is larger than the diameter on both end sides, the transfer sheet 121 is pulled toward both end sides of the expander roll 110, and the tension is applied in the width direction. As described above, the transfer sheet 121 is positioned in the width direction by the guide groove 111a formed in the expander roll 110, so that the tension in the width direction is applied and the transfer sheet 121 and the positive electrode sheet member 300 become parallel to each other, and the transfer step S21 described below is performed while maintaining this parallel state.

The transfer step S21 is a step of transferring the first solid electrolyte layer SE1 on the transfer sheet 121, to which the tension has been applied, to the positive electrode sheet member 300. Specifically, the first solid electrolyte layer SE1 on the positive electrode sheet member 300 is passed through while being pressed by the pair of first positive electrode transfer rollers 120, thereby performing the transfer pressing. The pressure in this case is, for example, 50 MPa to 500 MPa at a predetermined temperature (for example, 10°C to 150°C). Preferably, the pressure is 100 MPa at 25°C.

The peeling step S3 is a step of peeling the base material sheet 123 from the first solid electrolyte layer SE1 after the transfer step S21. Specifically, the base material sheet 123 is peeled off by the peeling roller 130 from the first solid electrolyte layer SE1 that has been transfer-pressed in the transfer step S21. The peeled base material sheet 123 is then wound up by the base material roll body 131.

The tension control step S4 is a step of controlling the tension applied to the positive electrode sheet member 300 to which the first solid electrolyte layer SE1 has been transferred, generated by the transferring in the transfer step S21 and the peeling in the peeling step S3. That is, the pressure applied to the positive electrode sheet member 300 by the above-mentioned vertically movable guide rolls 180 in the transfer step S21 is released or reduced, thereby making the tension applied to the positive electrode sheet member 300 uniform. In this way, it is possible to correct the distortion of the positive electrode sheet member 300 caused by the transferring in the transfer step S21 and the peeling in the peeling step S3. By performing such processing before the positive electrode press step S5 described below, the distortion of the positive electrode sheet member 300 can be adjusted before the positive electrode sheet member 300 to which the first solid electrolyte layer SE1 has been transferred is refined and densified, thereby preventing refinement and densification processing from being performed in a distorted state.

The positive electrode press step S5 is a step in which the positive electrode press roll 190 presses (stamps) the positive electrode sheet member 300 to which the first solid electrolyte layer SE1 has been transferred, on the same conveyance line as the above-mentioned transfer step S21, thereby refining and densifying the positive electrode sheet member 300 to which the first solid electrolyte layer SE1 has been transferred. A pressure applied in the positive electrode press step S5 is greater than the pressure applied in the transfer step S21. By pressing (stamping) with a pressure greater than that in the transfer step S21, a positive electrode is refined and densified. A pressing (stamping) pressure for densification is, for example, approximately 300 MPa to 1200 MPa at 25°C to 100°C. A densified laminate of the positive electrode sheet member 300 and the first solid electrolyte layer SE1 is conveyed to a downstream direction of the conveyance line.

In this way, by performing the transfer step S21 and the positive electrode press step S5 on the same conveyance line, the accuracy of the transferring can be improved, and appropriate refinement and densification can be achieved, as compared with a case of, for example, performing the transfer step S21 and the positive electrode press step S5 on separate lines.

The second solid electrolyte layer transfer step S6 is a step of transferring, by the second positive electrode transfer roller 140, the second solid electrolyte layer SE2 to the positive electrode sheet member 300 onto which the first solid electrolyte layer SE1 is transferred and pressed (stamped) after the positive electrode press step S5. Specifically, in the second solid electrolyte layer transfer step S6, the second solid electrolyte layer SE2 is positioned to be disposed within a range guided by a guide roller (not illustrated) on the positive electrode sheet member 300 to which the first solid electrolyte layer SE1 has been transferred. Then, the second solid electrolyte layer SE2 on the positive electrode sheet member 300 is passed through while being pressed by the second positive electrode transfer roller 140 serving as a transfer roller, thereby performing the transfer pressing. The pressure in this case is, for example, 50 MPa to 500 MPa at a predetermined temperature (for example, 10°C to 150°C). In this way, the positive electrode sheet member 300 is pressed twice or more. Preferably, the pressure is 150 MPa at 25°C.

Meanwhile, the negative electrode sheet member 310 is prepared at a position away from the conveyance line. First, as illustrated on an upper side of FIG. 5, the intermediate layer 5 is transferred, by the intermediate layer transfer roller 150, to the negative electrode active material layer 21 laminated on the negative electrode current collecting foil 22a (intermediate layer transfer step S7). Then, as illustrated on a lower side of FIG. 5, the negative electrode sheet member 310 is formed by transferring the negative electrode side solid electrolyte layer SE3 to the intermediate layer 5 by the negative electrode transfer roller 160 (negative electrode side solid electrolyte layer transfer step S8). Accordingly, the intermediate layer 5 is disposed between the negative electrode active material layer 21 and the negative electrode side solid electrolyte layer SE3. Note that in the embodiment, the negative electrode sheet member 310 includes a laminate constituted by the negative electrode current collecting foil 22a, the negative electrode active material layer 21, the intermediate layer 5, and the negative electrode side solid electrolyte layer SE3, but alternatively, the negative electrode active material layer 21 and the intermediate layer 5 may not be included.

In the intermediate layer transfer step S7, the intermediate layer 5 is positioned to be disposed within a range guided by a guide roller (not illustrated) on the negative electrode active material layer 21. Then, the intermediate layer 5 on the negative electrode active material layer 21 is passed through while being pressed by the intermediate layer transfer roller 150 as a transfer roller to perform the intermediate layer transfer pressing for transferring the intermediate layer 5 to the negative electrode active material layer 21. The pressure in this case is, for example, 50 MPa to 800 MPa at a predetermined temperature (for example, 10°C to 150°C). More preferably, the pressure is in a range of 300 MPa or more and 800 MPa or less at 25°C.

In the negative electrode side solid electrolyte layer transfer step S8, the negative electrode side solid electrolyte layer SE3 is positioned to be disposed within a range guided by a guide roller (not illustrated) on the intermediate layer 5. Then, the negative electrode side solid electrolyte layer SE3 on the intermediate layer 5 is passed through while being pressed by the negative electrode transfer roller 160 as a transfer roller, so that the negative electrode active material layer transfer pressing for transferring the negative electrode side solid electrolyte layer SE3 to the intermediate layer 5 is performed. The pressure in this case is, for example, 600 MPa to 800 MPa at a predetermined temperature (for example, 10°C to 150°C).

Note that regarding the pressure, the pressing (stamping) pressure in the positive electrode press step S5 is not only a maximum pressure value for pressing the positive electrode sheet member 300 but also a maximum pressure value in the entire method of the press device. The positive electrode sheet member 300 is pressed (stamped) at a high pressure to increase an energy density and refine the electrode 10. The maximum pressure value in the positive electrode press step S5 is equal to or greater than a maximum pressure value for pressing (stamping) the negative electrode sheet member 310.

The pressure during the transferring in the first solid electrolyte layer transfer step S2 and the second solid electrolyte layer transfer step S6 is smaller than the pressing (stamping) pressure in the positive electrode press step S5. The pressure during the transferring in the first solid electrolyte layer transfer step S2 and the second solid electrolyte layer transfer step S6 is smaller than the pressing (stamping) pressure in the negative electrode side solid electrolyte layer transfer step S8.

Since the first solid electrolyte layer SE1 and the second solid electrolyte layer SE2 contain a relatively large amount of binder, the pressing (stamping) pressure during transferring can be reduced. By setting the pressing (stamping) pressure in transferring as low as possible, elongation of the first solid electrolyte layer SE1 and the second solid electrolyte layer SE2 due to transfer pressing can be reduced. Therefore, it is possible to leave room for the first solid electrolyte layer SE1 and the second solid electrolyte layer SE2 to elongate in the subsequent integration press step S10 and the like, and the first solid electrolyte layer SE1 can elongate following the positive electrode layer 4. Accordingly, bondability between the first solid electrolyte layer SE1 and the positive electrode active material layer 41 can be improved.

Note that after the negative electrode side solid electrolyte layer transfer step S8, the formed negative electrode sheet member 310 is cut by a cutter in a state of being supported by a delivering roll that delivers the member subjected to the transferring in the negative electrode side solid electrolyte layer transfer step S8. The negative electrode sheet member 310 is cut to a designed dimension of the negative electrode layer 2 of the all-solid-state battery 1.

As illustrated in FIGS. 2 and 6, the negative electrode sheet member 310 cut to the designed dimension is conveyed to the positive electrode sheet member 300 to join the conveyance line of the positive electrode sheet member 300, and is laminated on the positive electrode sheet member 300. In this case, before the integration press step S10 described below, a lower layer side on a surface of the positive electrode sheet member 300 facing the negative electrode side solid electrolyte layer SE3 is provided with the first solid electrolyte layer SE1, and the second solid electrolyte layer SE2 is provided thereon. Then, the negative electrode sheet member 310 is disposed on the positive electrode sheet member 300 in a cut state.

Specifically, in the negative electrode sheet member lamination step S9, the negative electrode sheet member 310 to which the negative electrode side solid electrolyte layer SE3 has been transferred is conveyed to and laminated on, by the negative electrode sheet member lamination roller 170, the positive electrode sheet member 300 to which the first solid electrolyte layer SE1 and the second solid electrolyte layer SE2 have been transferred. In the negative electrode sheet member lamination step S9, the negative electrode sheet member 310 cut to the designed dimension is positioned on the positive electrode sheet member 300, to which the first solid electrolyte layer SE1 and the second solid electrolyte layer SE2 have been transferred, so as to be disposed within a range guided by a guide roller (not illustrated).

In this way, in a state in which the positive electrode sheet member 300 and the negative electrode sheet member 310 are laminated, the electrode 10 is pressed (stamped) by the integration press roll 200 so as to be integrated (integration press step S10). In a state immediately before the integration press step S10, regarding thicknesses in a lamination direction of the negative electrode sheet member 310 and the positive electrode sheet member 300, the thickness of the positive electrode sheet member 300 is greater than the thickness of the negative electrode sheet member 310. A pressure in this case is, for example, approximately 500 MPa to 900 MPa at 25°C to 100°C. By the integration press step S10, the positive electrode sheet member 300 and the negative electrode sheet member 310 are integrated, and at the same time, the first solid electrolyte layer SE1, the second solid electrolyte layer SE2, and the negative electrode side solid electrolyte layer SE3 are densified. When the pressing (stamping) pressures in the integration press step S10 and the positive electrode press step S5 are compared with each other, the pressing pressure in the positive electrode press step S5 is higher than the pressing (stamping) pressure in the integration press step S10.

After the integration press step S10, the formed electrode 10 is cut by a rotary cutter.

Note that each processing of the transferring of the first solid electrolyte layer SE1 in the first solid electrolyte layer transfer step S2, the peeling of the base material sheet 123 om the peeling step S3, the pressing (stamping) of the positive electrode sheet member 300 in the positive electrode press step S5, the transferring of the second solid electrolyte layer SE2 in the second solid electrolyte layer transfer step S6, the laminating of the negative electrode sheet member 310 before integration in the negative electrode sheet member lamination step S9, and the integration pressing (stamping) in the integration press step S10 is performed on both surfaces of the positive electrode sheet member 300 fed in the positive electrode sheet member feeding step S1. Accordingly, the all-solid-state battery 1 in which the layers are symmetrically laminated on both upper and lower surfaces with the positive electrode sheet member 300 interposed therebetween is obtained.

Although the embodiment has been described above with reference to the drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, the constituent elements in the above embodiment may be freely combined without departing from the gist of the invention.

For example, in the above embodiment, various solid electrolyte layers are laminated on both surfaces of the positive electrode sheet member 300, but alternatively, the lamination may be performed on only one surface. In the above embodiment, the transfer sheet 121 is provided on both surfaces of the positive electrode sheet member 300, but the transfer sheet 121 may be provided only on one surface.

In the present specification, at least the following matters are described. Although corresponding constituent elements in the embodiment described above are shown in parentheses, the present invention is not limited thereto.

(1) A method of manufacturing an all-solid-state battery (all-solid-state battery 1), in which a solid electrolyte layer (first solid electrolyte layer SE1) is pressed onto a positive electrode sheet member (positive electrode sheet member 300), the method including:

a transfer step (transfer step S21) of transferring the solid electrolyte layer to the positive electrode sheet member; and

a positive electrode press step (positive electrode press step S5) of refining the solid electrolyte layer transferred in the transfer step and the positive electrode sheet member on a same line.

According to (1), by performing the transfer step and the positive electrode press step on the same line, it is possible to improve the accuracy of the transferring and refinement on the solid electrolyte layer and the positive electrode sheet member, as compared with, for example, a case where each step is performed on a separate line. In other words, if each step is performed on a separate line, errors may occur when attaching the solid electrolyte layer to the positive electrode sheet member, but by performing the steps on the same line, it is possible to reduce the occurrence of such errors and the like, and improve adhesion between the solid electrolyte layer and the positive electrode sheet member and accuracy of formation of an interface therebetween.

(2) The method of manufacturing the all-solid-state battery according to (1), in which

a peelable base material (base material sheet 123) is provided on the solid electrolyte layer,

the method further includes a peeling step (peeling step S3) of peeling the base material from the solid electrolyte layer, and

in the peeling step, the base material is peeled from the solid electrolyte layer after the transfer step and before the positive electrode press step.

According to (2), after the solid electrolyte layer is transferred to the positive electrode sheet member, the base material can be peeled off from the solid electrolyte layer.

(3) The method of manufacturing the all-solid-state battery according to (2), further including:

a tension control step (tension control step S4) of controlling a tension applied to the positive electrode sheet member to which the solid electrolyte layer is transferred, the tension being applied by the transferring in the transfer step and the peeling in the peeling step, in which

in the tension control step, the tension applied to the positive electrode sheet member to which the solid electrolyte layer is transferred is controlled after the peeling step and before the positive electrode press step.

According to (3), the positive electrode sheet member to which the solid electrolyte layer has been transferred may be distorted in the transfer step and the peeling step, but by controlling and adjusting the tension in the tension control step, the tension applied to the positive electrode sheet member can be made uniform, and as a result, it becomes possible to correct the distortion of the positive electrode sheet member.

(4) The method of manufacturing the all-solid-state battery according to (1) or (2), in which

an applied pressure in the positive electrode press step is greater than an applied pressure in the transfer step.

According to (4), by applying a higher pressure in the positive electrode press step, the solid electrolyte layer and the positive electrode sheet member can be refined and densified.

(5) The method of manufacturing the all-solid-state battery according to (4), in which

the applied pressure in the positive electrode press step is 300 MPa to 1200 MPa.

According to (5), the solid electrolyte layer and the positive electrode sheet member can be pressed reliably by pressing with a large pressure.

(6 ) The method of manufacturing the all-solid-state battery according to (1) or (2), in which

in the positive electrode press step, the solid electrolyte layer transferred in the transfer step and the positive electrode sheet member are pressed by a pair of positive electrode press rolls (positive electrode press roll 190) plated with hard chromium.

According to (6), corrosion resistance and wear resistance of the positive electrode press roll can be improved by hard chromium plating.

(7) The method of manufacturing the all-solid-state battery according to (6), in which

in the transfer step, the solid electrolyte layer is pressed onto the positive electrode sheet member by a pair of transfer rolls (first positive electrode transfer roller 120), and

an outer diameter of each of the positive electrode press rolls is larger than an outer diameter of each of the transfer rolls.

According to (7), the diameter of the rolls for the positive electrode pressing is larger than that of the rolls for the transfer pressing, so that the solid electrolyte layer and the positive electrode side sheet member can be reliably refined and densified.

(8) The method of manufacturing the all-solid-state battery according to (1) or (2), in which

the solid electrolyte layers are provided on both surface sides of the positive electrode sheet member interposed between the solid electrolyte layers.

According to (8), the solid electrolyte layer can be transferred to both surfaces of the positive electrode sheet member.

(9) The method of manufacturing the all-solid-state battery according to (1) or (2), further including:

a positive electrode sheet member feeding step (positive electrode sheet member feeding step S1) of feeding out the positive electrode sheet member having a positive electrode active material layer (positive electrode active material layer 41) laminated on a positive electrode current collecting foil (positive electrode current collecting foil 42a);

a negative electrode side solid electrolyte layer transfer step (negative electrode side solid electrolyte layer transfer step S8) of forming a negative electrode sheet member (negative electrode sheet member 310) by transferring a negative electrode side solid electrolyte layer (negative electrode side solid electrolyte layer SE3) to a negative electrode active material layer (negative electrode active material layer 21) laminated on a negative electrode current collecting foil (negative electrode current collecting foil 22a);

a negative electrode sheet member lamination step (negative electrode sheet member lamination step S9) of laminating the negative electrode sheet member to which the negative electrode side solid electrolyte layer is transferred on the positive electrode sheet member to which the solid electrolyte layer is transferred; and

an integration press step (integration press step S10) of pressing the positive electrode sheet member and the negative electrode sheet member in a laminated state to integrate an electrode (electrode 10), in which

the transfer step, the positive electrode press step, the negative electrode sheet member lamination step, and the integration press step are performed on the same line with respect to the positive electrode sheet member.

According to (9), the transfer step, the positive electrode press step, the negative electrode sheet member lamination step, and the integration press step are performed on the same line on the positive electrode sheet member, thereby improving the adhesion between each layer and the accuracy of the formation of interfaces as compared with, for example, a case where each step is performed on a separate line.

What is claimed is:

1. A method of manufacturing an all-solid-state battery, wherein a solid electrolyte layer is pressed onto a positive electrode sheet member, the method comprising:
transferring the solid electrolyte layer to the positive electrode sheet member; and
refining the solid electrolyte layer transferred in the transferring and the positive electrode sheet member on a same line.

2. The method of -solid-state battery according to claim 1, wherein
a peelable base material is provided on the solid electrolyte layer,
the method further comprises peeling the base material from the solid electrolyte layer, and
in the peeling, the base material is peeled from the solid electrolyte layer after the transferring and before the refining.

3. The method of manufacturing the all-solid-state battery according to claim 2, further comprising:
controlling a tension applied to the positive electrode sheet member to which the solid electrolyte layer is transferred, the tension being applied by the transferring and the peeling, wherein
in the controlling the tension, the tension applied to the positive electrode sheet member to which the solid electrolyte layer is transferred is controlled after the peeling and before the refining.

4. The method of manufacturing the all-solid-state battery according to claim 1, wherein
an applied pressure in the refining is greater than an applied pressure in the transferring.

5. The method of manufacturing the all-solid-state battery according to claim 4, wherein
the applied pressure in the refining is 300 MPa to 1200 MPa.

6. The method of manufacturing the all-solid-state battery according to claim 1, wherein
in the refining, the solid electrolyte layer transferred in the transferring and the positive electrode sheet member are pressed by a pair of positive electrode press rolls plated with hard chromium.

7. The method of manufacturing the all-solid-state battery according to claim 6, wherein
in the transferring, the solid electrolyte layer is pressed onto the positive electrode sheet member by a pair of transfer rolls, and
an outer diameter of each of the positive electrode press rolls is larger than an outer diameter of each of the transfer rolls.

8. The method of manufacturing the all-solid-state battery according to claim 1, wherein
the solid electrolyte layers are provided on both surface sides of the positive electrode sheet member interposed between the solid electrolyte layers.

9. The method of manufacturing the all-solid-state battery according to claim 1, further comprising:
feeding out the positive electrode sheet member having a positive electrode active material layer laminated on a positive electrode current collecting foil;
forming a negative electrode sheet member by transferring a negative electrode side solid electrolyte layer to a negative electrode active material layer laminated on a negative electrode current collecting foil;
laminating the negative electrode sheet member to which the negative electrode side solid electrolyte layer is transferred on the positive electrode sheet member to which the solid electrolyte layer is transferred; and
pressing the positive electrode sheet member and the negative electrode sheet member in a laminated state to integrate an electrode, wherein
the transferring, the refining, the laminating, and the pressing are performed on the same line with respect to the positive electrode sheet member.
